(19) United States
(12) Patent Application Publication
(10) Pub. No.: US 2007/0272223 A1
(43) Pub. Date: Nov. 29, 2007

(54) Method for maintaining a polished concrete floor

(76) Inventors: Jeffrey Stuckey, Kent, OH (US); Joseph Owens, North Wales, PA (US); Joseph Urbanic, Hudson, OH (US)

Correspondence Address: BUCHANAN INGERSOLL & ROONEY PC, P.O. BOX 1404, ALEXANDRIA, VA, 22313-1404, US

(21) Appl. No.: 11/440,243

(22) Filed: May 24, 2006

(51) Int. Cl. B28D 5/00

(52) U.S. Cl. 125/30.01

(57) ABSTRACT

A method of maintaining and restoring the gloss of polished concrete, terrazzo, marble and granite floors utilizing floor maintenance machines is disclosed. The rotating head of the floor machines has either a brush having flexible bristles impregnated with abrasive particles or a maintenance pad having fibers which have been impregnated with an abrasive material and which are woven or otherwise distributed through the pad. The use of these abrasive pads and brushes with conventional floor maintenance machinery in routine floor maintenance operations maintains or restores the gloss of non-resilient flooring that is exposed to heavy traffic.

### FIELD OF INVENTION

The invention relates to restoring and maintaining the gloss of mechanically polished concrete and terrazzo floors.

### BACKGROUND OF THE INVENTION

The art of mechanically polishing concrete and terrazzo floors is practiced largely in the manner taught in U.S. Pat. No. 6,454,632, which discloses a method of hardening and polishing concrete floors. Mechanical polishing of concrete and terrazzo is done with very heavy vertical shaft rotary grinding machines fitted with metal or resin disks that are imbedded with diamond abrasives of varying grit sizes. The equipment is described in U.S. Pat. Nos. 3,098,329, 3,117,401 and 5,042,298 as well as published application 2006/0025059. A sequence of increasingly finer grit diamond abrasives are used to grind the floor until it is smoothed to the desired level of gloss. Once exposed to pedestrian traffic and fork lifts, tow motors, and other wheeled vehicle traffic, the polished concrete or terrazzo floor slowly loses its gloss. Gloss loss in traffic is due to abrasion, spills of mildly acidic materials, such as citrus juices, carbonated beverages, and even acid rain, and the deposition of soils on the polished surface. Routine cleaning of the floor will remove the latter and it may also prolong the time that the gloss remains since it removes abrasive soils, but gloss loss is inevitable for a floor open to traffic.

The gloss of a mechanically polished concrete or terrazzo floor can be restored by applying a finish or coating, as is taught in, for example, U.S. Pat. No. 4,017,662, but all of the available coating materials are softer than the concrete surface and under traffic they lose their gloss even more rapidly than the original polished concrete or terrazzo.

The routine maintenance procedures for mechanically polished concrete and terrazzo flooring are derived directly from the routine maintenance procedures which have evolved and developed over the past 75 years for waxed or polished resilient flooring, such as linoleum, cork, rubber, vinyl, or vinyl-composition tiles and sheet. These resilient flooring materials and their finishes are relatively soft, making them readily scuffed, scratched, and marred, and the finishes are chemically sensitive to solvents and alkaline materials. For these reasons routine floor maintenance of resilient floors has been forced to be chemically and mechanically mild and non-aggressive.

Routine cleaning maintenance of resilient flooring uses either mild (neutral or only very mildly alkaline) cleaning chemicals with a cloth mop, or the same chemicals with a standard rotary floor machine (also called a ‘swing’ floor machine) fitted with a non-abrasive pad, or even less aggressive cleaning solutions with an auto-scrub machine and the same non-abrasive pad. An auto-scrub machine (also called a mobile hard surface floor cleaner, see U.S. Pat. No. 6,585,827 for example) is a more efficient (greater floor surface coverage per man-hour), automatic version of the standard floor machine, with an integral wet-vac and less weight applied to the floor pad. These routine cleaning procedures are also used for polished concrete and terrazzo. The mild chemicals and non-aggressive mechanical agitation of the cleaning equipment is less than optimal for concrete and terrazzo flooring, because of their heavier loadings of more aggressive traffic, but cleaning by the techniques developed for resilient flooring and finishes is sufficient. Other than removal of surface soils which detract from gloss, routine, conventional cleaning has no restorative effect on the gloss of either resilient flooring or mechanically polished concrete and terrazzo.

Standard floor machines and autoscrubbers are designed to drive either brushes or floor pads to mechanically agitate the cleaning solution and remove soils. The brushes are typically constructed of nylon, polyester, or other relatively flexible, extruded fibers, though natural fiber bristle brushes are also available. In routine cleaning of non-resilient flooring, brushes are generally avoided because of their tendency to scratch, dull, and damage the polish or flooring surface and abrade away excessive amounts of the polish film.

Floor cleaning pads are constructed of non-woven extruded synthetic fibers, such as polyester or nylon. They are available in a range of aggressiveness or stiffness which is engineered into the pad structure through the selection of the composition or the fibers or the blend ratio of various fibers, the diameter of the fibers, the stiffness of the non-woven binder, and the density of the fiber packing in the pad (high fiber packing distributes the pad pressure of the machine over more floor-contact points, decreasing the effective abrasiveness of each contact point). In the almost universally accepted color code system for the stiffness of scrubbing pads (based on the commercial product code developed by 3M for their pads), a red pad is generally used for auto-scrubbing and swing machine cleaning. More aggressive blue and green scrubbing pads are rarely used, and then only for heavily engrained soils that require some polish surface removal in order to clean the floor.

Gloss can be restored to resilient flooring and floor coatings by periodically performing spray buffing or high speed burnishing maintenance procedures. These gloss-restoration methods are not effective for non-resilient flooring.

Typically, spray buffing is accomplished by using a swing floor machine fitted with a red cleaning pad. A liquid ‘spray buffing medium’ is sprayed onto the floor to lubricate the pad (reduce its abrasion) and to chemically soften the finish or flooring surface. Spray buffing mechanically abrades and removes the softened surface of the polish film and the scuff marks, scratches, and other traffic damage that are concentrated on the surface. Though spray buffing is primarily used to repair traffic damage, a skilled spray buff operator can also restore the gloss of resilient floors and floor finishes.

Because of their much higher hardness, polished concrete and terrazzo floors do not show the same types of traffic damage as do resilient floors and floor finishes. This greater harness also makes these non-resilient floors immune to the mild mechanical abrasion that is responsible for the spray buffing effects. Spray buffing is ineffective in restoring the gloss of these hard floors, and so it is not used.

High speed burnishing is a periodic routine maintenance procedure used to restore the gloss of resilient flooring and floor finishes. It uses a specially designed large diameter straight-line floor machine operating at 1000 to 2500 rpm with a very soft, dry pad to mechanically abrade and smooth the top surface of the polish film. These high speed burnishing pads are usually softer than the red cleaning pads used for spray buffing. Light scuff marks are often removed by high speed burnishing, but the procedure is designed and intended for gloss restoration, rather than repair of traffic damage. Non-resilient polished concrete and terrazzo floors do not respond to high speed burnishing gloss restoration because of their higher hardness and the reduced abrasion (greater softness) and low pressure applied to the high speed burnishing pad.

In a moderate traffic commercial environment, cleaning is typically done on a daily basis. High speed burnishing gloss restoration is done daily or on a less frequent schedule, depending on traffic density and the durability of the polish. Spray buffing is the most aggressive of these routine procedures in that it abrasively removes the greatest amount of polish. It is labor intensive (expensive) and results are dependent on the operator's skill, so in most facilities it is either no longer practiced or is done only on a monthly or even less frequent schedule.

Gloss restoration for traffic-damaged resilient floor finishes is also accomplished by top-coating the damaged floor with an additional coat of polish. Though the application of a floor finish to polished concrete or terrazzo floors is possible, as taught in the Gehman reference, this option negates the greater durability and resistance to traffic damage of these non-resilient floors, making them unsuitable for their heavier traffic loadings. The gloss of the relatively soft finish is lost much more rapidly than the gloss of the inherently more durable non-resilient surface, making it necessary to frequently strip off the old finish and apply more.

More aggressive procedures and equipment have been developed for special, non-routine cleaning of resilient flooring. These include stripping or removal of irretrievably soiled or damaged polish films and removal of peculiar stains and soils which have penetrate through a polish film and into the resilient tile. For these special cleaning operations, brushes and more aggressive pads are used, including some brushes and pads which have abrasives adhered or integral to the pad fibers or brush bristles. These more aggressive procedures and equipment are avoided as much as possible because they are known to damage the resilient floors. Polishes are stripped as infrequently as possible, typically only once every one to three years, and abrasive removal of stains from a floor is attempted only as a last resort before replacing the flooring. The use of this more aggressive cleaning equipment is often avoided, even for infrequent use, because it abrades away or otherwise damages the expensive floor tiles. The product literature and package labeling warn against the routine use of these aggressive pads and brushes because they will dull, scarify, and scratch the flooring, drastically reducing the gloss that can be attained even after reapplication of multiple coats of finish.

The very aggressive cleaning pads and brushes designed for special, infrequent use on resilient floors will not damage polished concrete and terrazzo or other non-resilient floors. The habits and experience from the entire evolution of cleaning maintenance of resilient floors which has been transferred to non-resilient flooring has limited the use of aggressively abrasive pads and brushes to non-routine cases of heavily soiled concrete (for example, the removal of oils, paints, or exhausted sealer films). Even on these surfaces that would not be expected to be damaged by the aggressive brushes, they are not used in routine maintenance.

The lore and practice of janitorial maintenance on all types of flooring, and the available janitorial floor maintenance equipment is heavily biased toward protecting resilient flooring from chemical and mechanical damage by maintenance practices. Highly aggressive maintenance equipment, such as abrasive pads and brushes, bear explicit warnings against their routine use because of the damage that they may do to the floor. These warnings also caution against their routine use on non-resilient floors, including polished concrete and terrazzo, because of the anticipated danger of scarifying and reducing the gloss of these expensively produced floors.

Because of the much greater shear strength and abrasion resistance of concrete, the maintenance practices that restore or enhance the gloss of resilient floors have been of no use for polished concrete or terrazzo. When a polished concrete or terrazzo floor loses its gloss, which will happen inevitably from the uneven abrasion of traffic, the current recourse is to again polish the floor by the same diamond-grinding techniques used to initially polish it. This alternative is often not practicable because of its high cost for labor and materials, including the diamond grinding blocks, the attendant generation of heavy concrete dust or a water/concrete powder slurry that is not compatible with a building in service, and the prolonged time the floor must be taken out of service.

There is a need for a routine method of restoring the gloss of polished concrete and terrazzo floors that does not compromise the high resistance to heavy traffic of these floors. To be practicable for routine use, the method must employ equipment that is durable, available, relatively inexpensive, and easily incorporated into the other routine maintenance procedures for the floors, such as routine cleaning, or is within the range of experience of the janitorial staff from maintaining resilient flooring.

### SUMMARY OF THE INVENTION

We provide a method of restoring or maintaining the gloss of polished concrete or terrazzo floors, and an improvement on conventional floor maintenance equipment for routine use on polished concrete and terrazzo floors. This method may also be used on granite, marble, and other non-resilient floors. The improvement on conventional floor maintenance machines is in the form of cleaning pads or brush bristles which are impregnated with abrasive particles. Silicon carbide, diamond chips, or other abrasives which are harder than the concrete floor materials may be used as the abrasive particles. The bristles are preferably nylon, though other extrudable materials may be used.

Conventional floor maintenance machinery fitted with an abrasive pad or brush is operated over the polished concrete or terrazzo floor in the same manner as for the maintenance of resilient flooring. The routine operation of the improved maintenance equipment of this invention will restore or maintain the gloss of the polished concrete or terrazzo floor.

The routine use of an improved autoscrub machine, fitted with an abrasive-impregnated scrubbing brush or pad will simultaneously clean the floor and smooth the incremental damage due to traffic so that the gloss of the polished concrete or terrazzo floor is maintained. A swing machine fitted with an abrasive-impregnated scrubbing brush or cleaning pad will, in a periodic spray buffing maintenance operation, restore the gloss of traffic abraded polished concrete or terrazzo flooring. Routine high speed burnishing with an abrasive-impregnated pad or brush will restore the gloss of polished concrete or terrazzo flooring.

Other objects and advantages of our method should become apparent from the description of certain present preferred embodiments thereof.

### BRIEF DESCRIPTION OF THE FIGURES

FIG. 1 is a perspective view of a swing floor maintenance machine that can be used in our method.

FIG. 2 is a side view of an enlarged portion of a floor maintenance brush used in a first present preferred embodiment of our method.

FIG. 3 is a perspective view of an enlarged portion of a floor maintenance pad used in a second present preferred embodiment of our method.

FIG. 3a is an enlarged view of a portion of the fibers within the circle in FIG. 3.

### DESCRIPTION OF THE PREFERRED EMBODIMENTS

The present method and apparatus are intended to be used daily or multiple times per week. Such frequency of use is commonly considered to be routine maintenance. Our method can be used with many types of floor maintenance machinery including conventional autoscrub floor cleaners. Autoscrub janitorial machines have a rotating head to drive an affixed pad or brush in contact with the floor, a reservoir tank for holding water and detergent solution, metering valves for introducing the cleaning solution to the floor and rotating brushes or pads, an integral squeegee and wet vac to remove the soils and spent cleaning solution, a holding tank for the spent cleaning solution, and motors and power supply (electric batteries are most common, but internal combustion engines and electrical extension cords also serve) to drive the vertical axis rotating pads or brushes. The machines may be self propelled or propelled by the operator. When the conventional cleaning pad of the autoscrub machine is replaced with the abrasive impregnated brush or pad of this invention, the routine cleaning operation on a polished concrete or terrazzo floor will also serve to abrasively smooth the floor surface and restore the gloss that has been lost through exposure to traffic.

The traffic-induced abrasive loss of gloss by a polished non-resilient floor is a slow, but cumulative process and effect. In order to maintain the initial gloss of the floor it is only necessary to smoothly and uniformly abrade the floor sufficiently to offset the uneven wear from traffic that has happened since the last gloss maintaining or restoring process. The routine use of the cleaning machines of the type here disclosed provides that required level of smoothing so that the original gloss is maintained. As an additional advantage, the more aggressive mechanical agitation of the improved pad or brush provides better cleaning than is possible with the conventional scrubbing pads designed to minimize maintenance damage to resilient flooring and finishes.

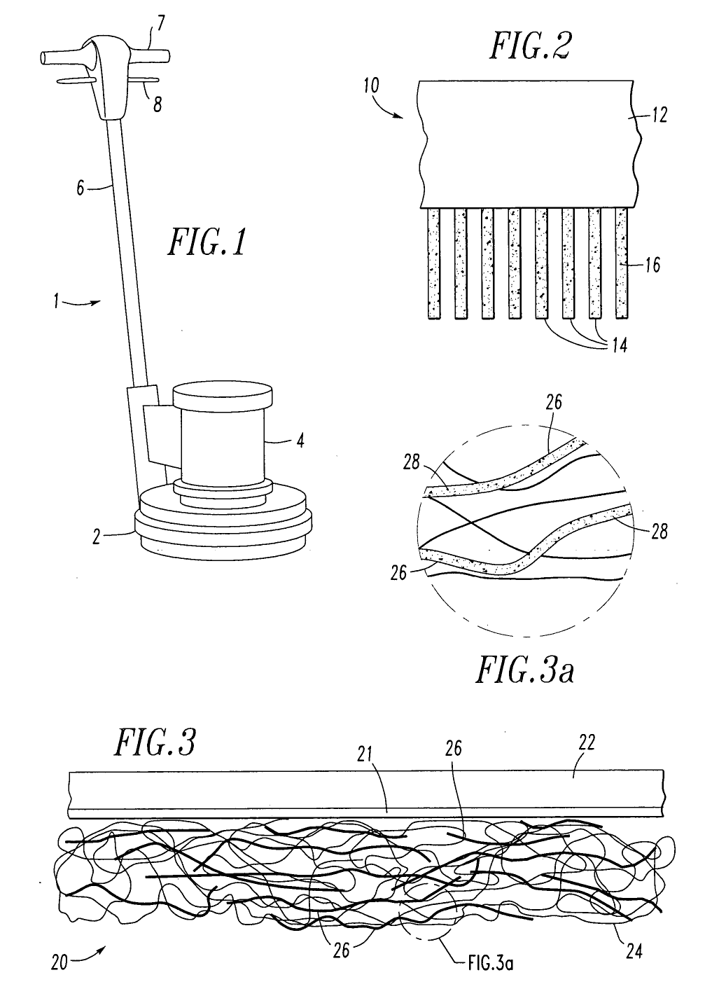

Another type of floor maintenance machine that can be used is the swing machine 1 shown in FIG. 1. This type of polisher has a rotating head 2, to which a brush or a pad or brush is affixed, that is driven by a motor contained in the housing 4. A handle 6 extends from the housing and contains hand grips 7. The controls 8 for operating the motor are provided on the handle near the hand grip. We provide a brush 10 or floor maintenance pad 20 of the type shown in FIGS. 2 and 3. The brush has a base 12 from which a plurality of bristles 14 extend.

The bristles preferably are nylon, but could be any suitable material. Preferably each bristle is impregnated with an abrasive material 16. However, some of the bristles may be of conventional construction and contain no abrasive particles. Consequently, when the brush is rotated in the polisher 1, some of the abrasive particles will contact the floor being polished. We prefer to use silicon carbide as the abrasive. However, other abrasive materials could be used.

In an alternative embodiment we provide a floor maintenance pad 20 which is attached to a rigid pad driver 22 by an adhesive 21 or other conventional means. The pad fibers 24 can be any type of material conventionally used or which could be used in floor maintenance pads. This includes both woven and non-woven materials, and the non-woven materials may be unbonded, fusion bonded, or bonded with chemical binders. We also provide a series of fibers 26 which have been impregnated with abrasive particles 28. The abrasive impregnated fibers are woven or otherwise distributed through the matrix of the pad 20. The fibers may be any desired length and can be distributed randomly or systematically through the fabric. The fibers are flexible and may vary in number and density in the pad depending upon the coarseness of the abrasive in fibers. Fewer fibers of larger diameter would be used for a coarser grit abrasive than for fibers having a finer abrasive. When the floor maintenance pad 20 is used some of the abrasive particles will contact the floor.

Typically the bristles or pad fibers would be extruded nylon material in which the abrasive particles have been added to the nylon prior to extrusion. While we prefer to use silicon carbide as the abrasive, one might also use titanium carbide, diamond chips, boron nitride, aluminum oxide or ceramic grains. The choice of abrasive may depend upon the material used for the bristles or fibers. Particles must be of such a size and nature so that when incorporated into the bristle or fiber the structure of the bristle or fiber will not be weakened such that the bristle or fiber might readily break. Typically, such particles would range in grit sizes from 40 to 3500. We prefer that the diameter of the bristles or fibers be comparable to those used in conventional brushes and maintenance pads. Such diameter may range between 0.012 inches and 0.070 inches. Smaller diameters tend to be more flexible and are preferred. The length of the bristles may vary from about 0.75 inch to 5 inches. However, we prefer that bristle length of 2 inches be used. Any length of fiber in the maintenance pad is acceptable, as long it is sufficient to maintain the integrity of the pad under the centripetal force of the rotation of the pad driver. The amount of particles that are impregnated into the bristles and fibers will vary according to the diameter of the abrasive particles. The objective is to have a bristle or fiber that is sufficiently flexible to maintain abrasive contact with the floor, even over irregularities in the floor. Larger size particles tend to stiffen the bristles. As particle size increases fewer particles are used. The particles may be randomly spaced throughout the bristle.

The present invention differs from most polishers and grinders having abrasive heads. In the prior art much more abrasive material comes in contact with the floor and at much higher pressure on the grinding head than occurs with the present invention. As a result, prior art polishers and grinders having abrasive heads tend to remove much of the polish and other surface treatment from the floor, or indeed the cementitious surface itself. The resulting floor surface has lower gloss and a more porous structure. The greater volume of material removed also generates objectionable amounts of dust or creates a difficult to dispose cement/water slurry, neither of which are acceptable in a facility that is occupied and so are not acceptable for routine maintenance of polished concrete or terrazzo floors.

Our bristles impregnated with an abrasive material as well as the pad having fibers impregnated with abrasive material, when affixed to conventional floor maintenance machines which produce only light pressure on the pad or brush, provides a light abrasion that in fact polishes the concrete while cleaning the concrete.

Others have proposed achieving the same effect by adhering diamond chips to the fiber surfaces of a cleaning pad. Such a pad has been sold under the name HTC Twister. However, the Twister pad has a limited life because the diamond abrasive chips are lost from the pad as the soft binder or adhesive is abraded or melts from the heat of friction. After being passed over about 250,000 square feet of floor the HTC Twister pad must be replaced. In contrast, a brush made in accordance with the present invention having nylon bristles impregnated with silicon carbide abrasive particles was used for six months having been used to maintain the gloss of approximately 1,300,000 square feet. After that amount of service the brush was removed from service for examination, but it could still have been continued in service. We expect that a pad woven of abrasive-impregnated fibers as here disclosed would have a similar life.

The present method has been tested and demonstrated in two commercial establishments and has been shown improved gloss retention relative to conventionally maintained mechanically polished concrete floors. In these demonstrations a conventional autoscrub floor cleaning machine was fitted with a rotating brush having nylon brush bristles that had been impregnated with silicon carbide particles. The autoscrub was operated over the polished concrete floor each evening as in a routine cleaning operation, for a period of one month. The gloss of the floors was improved and, perhaps most importantly, the presence of traffic lanes of wear (usually seen as lower gloss in the areas of greatest traffic density) were eliminated. The routine use of the auto-scrub brushes having abrasive impregnated within the bristles of this invention was the only deviation from standard maintenance practices on the polished concrete floors in these tests. The results of the tests demonstrate that this method can provide a relatively inexpensive procedure for maintaining the uniform high level of gloss initially created by polishing the concrete floors.

In these demonstrations the abrasive was silicon carbide, impregnated in nylon brush bristles of a conventional manufacture. However, one could use other abrasives, such as diamonds, boron nitride, titanium carbide, aluminum oxide, or ceramic grains. The choice of abrasive is limited only to those materials which are sufficiently hard to abrade the cured concrete surface and which can be wet-out by the material of the bristle fiber matrix so that the abrasive is impregnated within the bristle without weakening the fiber structure.

Rather than just maintaining the gloss of polished concrete and terrazzo floors by routine auto-scrubbing with cleaning pads and brushes which have abrasive-impregnated fibers and bristles, we have discovered that, if the gloss of these non-resilient floors has been degraded because the above gloss maintenance procedure was not done, the initial gloss may be restored and then maintained by spray buffing and high speed burnishing with similar pads and brushes.

Spray buffing of polished concrete and terrazzo floors utilizes a swing machine in which the full weight of the machine is applied to the abrasive-impregnated spray buffing pad or brush. In order to avoid scoring and scratching of the non-resilient floor by the abrasives in the pad fibers or brush bristles, it is necessary to lubricate the floor and abrasives. This is done most conveniently by spraying the floor immediately in front of the machine path with a simple blend of surfactant and water as a spray buffing medium. Excessive lubrication with the spray buffing medium will not allow the process to abrasively smooth the floor, and inadequate lubrication with the spray buffing medium will allow the abrasive pad or brush to scratch and dull the gloss of the floor, so spray buffing of these non-resilient floors is still dependent on the skill and experience of the operator.

Though both a floor cleaning pad constructed of abrasive-impregnated fibers and a brush with abrasive-impregnated bristles are effective in restoring the gloss of polished concrete and terrazzo floors, to minimize the dependence on the operator's skills, it is preferred that an abrasive-impregnated pad be used instead of a brush for spray buff gloss restoration. The pad provides more contact points with the floor, reducing the pressure applied to each point, and thus the sensitivity of the process to the amount of lubricant applied. The pad is also capable of holding the small amount of damp (from the spray buffing medium) concrete powder that is a by-product of this abrasive smoothing process.

The low productivity of a swing floor machine dictates that spray buffing of polished concrete and terrazzo is not an economical process for maintaining the gloss of these non-resilient floors. It is more suitable as a gloss restoration procedure to be done with a low frequency of operation, rather than as a high frequency gloss maintenance operation.

High speed burnishing with pads and brushes which have abrasive-impregnated fibers and bristles is both a gloss restoration and a gloss maintenance process, depending on the frequency of the operation and the aggressiveness of the pad or brush. High speed burnishing equipment is designed so that only a fraction of the weight of the machine is placed on the brush or pad so that the machine can be operated in a straight-line path and the pad or brush can be rotated at high speed. This reduced pressure on the floor dictates that the pads or brushes used for high speed burnishing of these polished non-resilient floors be more aggressive than those used for spray buffing. The pads or brushes are constructed to be more aggressive by having less flexible or larger fiber or bristle diameters, heavier loadings of impregnated abrasive, larger particle size abrasive, harder abrasives, or combinations of these.

High rotational speed of the machine improves the smoothing action so that high gloss can be attained, but rotational speeds greater than about 1500 rpm (on a 21 inch diameter machine) generates sufficiently high centripetal forces that the contact point of brush bristles is along the side of the bristle, rather than the tip. This reduces the life cycle the bristles, so for rotational speeds greater than 1500 rpm it is preferred that high speed burnishing of polished concrete and terrazzo be done with pads constructed of abrasive-impregnated fibers, rather than brushes with abrasive-impregnated bristles.

Routine high speed burnishing, on a daily or multiple times weekly frequency is sufficient to maintain the gloss of polished concrete and terrazzo, if it is done with the abrasive-impregnated brushes and pads of this invention. Gloss restoration is obtained by multiple passes of the same high speed burnisher, but done with a lower frequency of operation.

While the brushes and pads disclosed have been shown to be effective in routine maintenance of polished concrete floors, they could also be used for routine maintenance of granite and marble floors. Typically, the art has used a mild acid solution and fine, loose abrasive particles to restore the gloss of marble floors. The acidic slurry of fine abrasive is rubbed across the surface of the floor with a weighted swing machine fitted with a soft cloth or carpet-based pad. If a brush or pad of the type disclosed here are used then no loose abrasive material or acidic chemicals are needed. Relative to the current art of restoring the gloss of polished marble, gloss restoration by the spray buffing procedure of this invention increases productivity from about 100 square feet per hour to about 1200 square feet per hour. High speed burnish restoration of gloss of polished marble will yield an increase in productivity to as much as 10,000 square feet per hour. In restoring the gloss of polished marble by spray buffing with an abrasive-impregnated pad or brush of this invention, the spray buffing medium may be weakly acidic, but that is not required for the effectiveness of the procedure.

Because granite is harder than marble and more resistant to acid attack, the gloss of polished granite flooring is only restored by the method of gradated diamond grinds used in the initial polishing of granite, concrete and terrazzo floors. The routine maintenance of granite flooring by the methods and equipment of this invention allows the gloss of this type of floor to be restored and maintained in the performance of routine floor maintenance operations. We have described and illustrated some, but not all, of the machines that can be used to practice our method. It should be understood that any machine used to maintain or clean floors to which a brush or pad is attached may be suitable for use in practicing our method.

Although we have described and illustrated certain present preferred embodiments of our method and machines that can be used to practice this method, it should be distinctly understood that the invention is not limited thereto, but may be variously embodied within the scope of the following claims.

1. An improved method of maintaining the gloss of a polished concrete, granite, marble or terrazzo floor in which a machine having a moving head is operated over the polished concrete, granite, marble or terrazzo floor in a cleaning operation in which acids that react with carbonates are not used, wherein the improvement comprises providing a brush on the moving head, the brush having bristles impregnated with abrasive particles.

2. The improved method of claim 1 wherein the abrasive particles are comprised of a material selected from the group consisting of silicon carbide, titanium carbide, boron nitride, aluminum oxide, ceramic grains and diamond chips.

3. The improved method of claim 1 wherein the abrasive-impregnated bristles are comprised of nylon.

4. The improved method of claim 1 wherein the machine is operated across the floor at least once per day.

5. The improved method of claim 1 wherein the machine is a conventional automatic scrubbing machine.

6. An improved method of maintaining the gloss of a polished concrete, granite, marble or terrazzo floor in which a machine having a moving head is operated over a polished concrete, granite, marble or terrazzo floor in a cleaning operation in which acids that react with carbonates are not used, wherein the improvement comprises providing on the moving head a cleaning pad having at least one fiber that is impregnated with abrasive particles.

7. The improved method of claim 6 wherein the abrasive particles are comprised of a material selected from the group consisting of silicon carbide, titanium carbide, boron nitride, aluminum oxide, ceramic grains and diamond chips.

8. The improved method of claim 6 wherein the machine is an automatic scrubbing machine.

9. An improved method of restoring the gloss of a polished concrete, granite, marble or terrazzo floor in which a spray buffing swing floor machine having a moving head is operated over the polished concrete, granite, marble or terrazzo floor in a spray buffing operation in which acids that react with carbonates are not used, wherein the improvement comprises providing a brush on the moving head, the brush having bristles impregnated with abrasive particles.

10. The improved method of claim 9 wherein the abrasive particles are comprised of a material selected from the group consisting of silicon carbide, titanium carbide, boron nitride, aluminum oxide, ceramic grains and diamond chips.

11. The improved method of claim 9 wherein the abrasive-impregnated bristles are comprised of nylon.

12. An improved method of restoring the gloss of a polished concrete, granite, marble or terrazzo floor in which a spray buffing swing floor machine having a moving head is operated over a polished concrete, granite, marble or terrazzo floor in a spray buffing operation in which acids that react with carbonates are not used, wherein the improvement comprises providing on the moving head a cleaning pad having at least one fiber that is impregnated with abrasive particles.

13. The improved method of claim 12 wherein the abrasive particles are comprised of a material selected from the group consisting of silicon carbide, titanium carbide, boron nitride, aluminum oxide, ceramic grains and diamond chips.

14. An improved method of maintaining and restoring the gloss of a polished concrete, granite, marble or terrazzo floor in which a high speed burnisher floor machine having a moving head is operated over the polished concrete, granite, marble or terrazzo floor in a high speed burnishing operation in which acids that react with carbonates are not used, wherein the improvement comprises providing a brush on the moving head, the brush having bristles impregnated with abrasive particles.

15. The improved method of claim 14 wherein the abrasive particles are comprised of a material selected from the group consisting of silicon carbide, titanium carbide, boron nitride, aluminum oxide, ceramic grains and diamond chips.

16. The improved method of claim 14 wherein the abrasive-impregnated bristles are comprised of nylon.

17. The improved method of claim 14 wherein the high speed burnisher is operated across the floor at least once per day.

18. An improved method of restoring and maintaining the gloss of a polished concrete, granite, marble or terrazzo floor in which a high speed burnisher floor machine having a moving head is operated over a polished concrete, granite, marble or terrazzo floor in a high speed burnishing operation in which acids that react with carbonates are not used, wherein the improvement comprises providing on the moving head a cleaning pad having at least one fiber that is impregnated with abrasive particles.

19. The improved method of claim 18 wherein the abrasive particles are comprised of a material selected from the group consisting of silicon carbide, titanium carbide, boron nitride, aluminum oxide, ceramic grains and diamond chips.

20. A cleaning pad for maintaining polished concrete, granite, marble or terrazzo floors comprised of a base, a fabric attached to the base and at least one flexible fiber distributed through the fabric such that opposite ends of the fiber do not extend beyond the fabric, the fiber comprised of an extruded polymer having abrasive particles distributed through the fiber.

21. The cleaning pad of claim 20 wherein the fabric is a woven material.

22. The cleaning pad of claim 20 wherein the fabric is a non-woven material.

23. The cleaning pad of claim 20 wherein the polymer is nylon.

24. The cleaning pad of claim 20 wherein the abrasive particles are comprised of a material selected from the group consisting of silicon carbide, titanium carbide, boron nitride, aluminum oxide, ceramic grains and diamond chips.
